(19) United States
(12) Patent Application Publication
(10) Pub. No.: US 2012/0314212 A1
(43) Pub. Date: Dec. 13, 2012

(54) INSPECTION DEVICE FOR BONDED WAFER USING LASER

(76) Inventors: Dong Young Jang, Seoul (KR); Seok-Kee Hong, Seoul (KR); Ho-Jin Hwang, Seoul (KR); Young-Hwan Lim, Seoul (KR); Chang-Woo Ban, Seoul (KR); Si-Eun Yang, Seoul (KR)

(21) Appl. No.: 13/511,112

(22) PCT Filed: Nov. 22, 2010
(86) PCT No.: PCT/KR10/08244

§ 371 Date: May 21, 2012

(30) Foreign Application Priority Data
Nov. 20, 2009 (KR) 10-2009-0112346

(51) Int. Cl. G01N 21/956; G01N 21/958

(52) U.S. Cl. 356/239.3

(57) ABSTRACT

Disclosed is a device for inspecting a bonded wafer using laser, which has a simple structure to facilitate an operation of the device and can detect an interface defect of the bonded wafer economically and highly reliably. To this end, the device for inspecting the bonded wafer using laser includes a laser unit, a laser diffusion unit, and a detection unit. If the device of inspecting the bonded wafer using laser according to the present invention is used, it is possible to advantageously inspect a wafer interface at a magnification desired by an inspector. In addition, the device has a simple structure, and thus it is advantageously easy to operate the device.

### CROSS-REFERENCES

This application claims the benefit of Korean Patent Application No. 10-2009-0112346, filed on Nov. 20, 2009, in the Korean Intellectual Property Office, the disclosure of which is incorporated herein in its entirety by reference.

### BACKGROUND OF THE INVENTION

1. Field of the Invention

The present invention relates to a wafer inspection device, and more particularly, to a device for inspecting a bonded wafer using laser that is economical and easily operates since the device has a simple structure for inspecting an interface defect of the bonded wafer using laser.

2. Description of the Related Art

Wafer bonding is a technology of forming and bonding silicon insulation layers on surfaces of two semiconductor substrates. Such wafer bonding is used in a silicon on insulator (SOI) wafer. The SOI wafer has a structure in which a buried insulation layer such as an oxide layer is disposed under a silicon single crystal layer used as an oxide layer that is a device manufacturing region of a surface layer with respect to a depth direction of the SOI wafer, and another silicon single crystal layer is disposed under the buried insulation layer.

The SOI wafer having the above structure has characteristics of a small parasitic capacity and a high radiation resistant ability. Thus, the SOI wafer is expected to have effects such as a high speed and low power consumption operation, a latch-up prevention, etc. and is spotlighted as a substrate for a high performance semiconductor device.

For the above reason, a research into manufacturing the SOI wafer by using the wafer bonding has been actively conducted, which resulted in development of a variety of manufacturing methods.

For example, Korean Patent Registration No. 10-0218541 (registered on Jun. 10, 1991) discloses “a method of manufacturing an SOI wafer”.

The method of manufacturing the SOI wafer comprises an operation of forming an oxide layer on an insulation substrate, an operation of bonding a silicon single crystal wafer and the oxide layer, an operation of forming photoresist on the silicon single crystal wafer in a circular shape, etching the silicon single crystal wafer, and removing the photoresist.

Korean Patent Registration No. 10-0498446 (registered on Jun. 22, 2005) discloses “an SOI wafer and a method of manufacturing the SOI wafer”.

The SOI wafer and the method of manufacturing the SOI wafer relate to a technology of reducing the number of manufacturing processes when a semiconductor device is manufactured and needing no additional process such as an epi growth, the SOI wafer comprising a first semiconductor substrate including a device isolation insulation layer formed to define a device forming region, a well and a burial layer formed in the device forming region on the first semiconductor substrate for each section, and a second semiconductor substrate bonded to the first semiconductor substrate, contacting a bottom portion of the device isolation insulation layer, and having a bonding insulation layer formed to electrically block a bottom portion of the device forming region.

Korean Patent Publication No. 10-2006-0069022 (registered on Jun. 21, 2006) discloses “a method of manufacturing an SOI wafer”.

The method relate to manufacturing the SOI wafer easily separating a hydrogen ion injection layer of a bonded wafer and having a remarkably low surface Rms value through a 2 step thermal processes of a low temperature below 500° C. and a low density of a hydrogen ion injection amount.

As described above, a variety of methods of manufacturing the SOI wafer using the wafer bonding has been developed owing to much research efforts. However, in a wafer using the bonding, a defect occurs in a wafer interface, i.e. a wafer defect occurs due to impurities or foam, etc. that may occur between wafer interfaces, which causes a problem that deteriorates performance of the wafer.

Such a wafer defect can be measured by using an optical microscope, an electronmicroscope, or a light point defect (LPD) measurement device after an etching process. However, such a method using the measurement device has a problem in that it is difficult to measure an accurate distribution, density, and size.

To solve the above problem, a device capable of measuring a defect of a wafer using an ultrasonic microscope has been developed.

For example, Korean Patent Registration No. 10-0571571 (registered on Apr. 10, 2006) discloses “a method of determining a defect of an SOI wafer using an ultrasonic microscope”.

The method of determining the defect of the SOI wafer using the ultrasonic microscope is a technology of measuring a non-bonding part present in a top silicon layer of the SOI wafer, a distribution of a hydrofluoric acid defect and a secco defect, a density, and size by using the ultrasonic microscope, which can advantageously detect the HF defect and the secco defect as well as the bonding defect of the SOI wafer. However, this technology using the ultrasonic microscope has a complicated structure, and thus disadvantageously it is not easy to operate and highly priced.

In addition to the method of measuring the defect of the wafer using ultrasonic waves, although a technology using an X-ray has been developed, it is disadvantageously highly priced, which causes a financial burden.

In addition to the measurement of the defect of the wafer using the ultrasonic waves or the X-ray, a method of measuring the defect of the wafer using infrared ray (IR) that has a simple structure, easily operates, and is economical in price has been developed. However, this technology uses various filters to produce wavelengthbands through which the wafer can pass, which does not output a clear image of the defect of the wafer, and thus it is disadvantageously difficult to determine the precise defect.

Accordingly, there is a need to develop equipment capable of measuring a defect of a wafer having a simple structure, easily operating, economical, and highly reliable.

### SUMMARY OF THE INVENTION

The present invention provides a device for inspecting a bonded wafer using laser, which has a simple structure to facilitate an operation of the device and can detect an interface defect of the bonded wafer economically and highly reliably.

According to an aspect of the present invention, there is provided a device for inspecting a bonded wafer using laser, the device including: a laser unit for emitting a laser beam used to inspect a defect between interfaces of the bonded wafer; a laser diffusion unit disposed between the laser unit and the bonded wafer so that the laser beam emitted from the laser unit can be diffused and irradiated onto the bonded wafer; and a detection unit for detecting whether a defect of the bonded wafer exists through the laser beam irradiated onto the bonded wafer and passing through the bonded wafer.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating a process of forming a bonded wafer to explain a device for inspecting the bonded wafer using laser according to an embodiment of the present invention;

FIG. 2 is a schematic inspection conceptual diagram for explaining a device for inspecting a bonded wafer using laser according to an embodiment of the present invention;

FIG. 3 is a schematic constructional diagram illustrating a device for inspecting a bonded wafer using laser according to an embodiment of the present invention;

FIGS. 4 through 6 are graphs illustrating an experiment for measuring an optimal laser uniformity of a device for inspecting a bonded wafer using laser according to an embodiment of the present invention;

FIG. 7 is a diagram illustrating a device for inspecting a bonded wafer using laser according to an embodiment of the present invention;

FIG. 8 is a perspective view illustrating the device of FIG. 9; and

FIG. 9 is a schematic construction diagram illustrating a diffusion unit movement member for explaining a device for inspecting a bonded wafer using laser according to an embodiment of the present invention.

### DETAILED DESCRIPTION OF THE INVENTION

Embodiments of the present invention will now be described in detail with reference to the accompanying drawings.

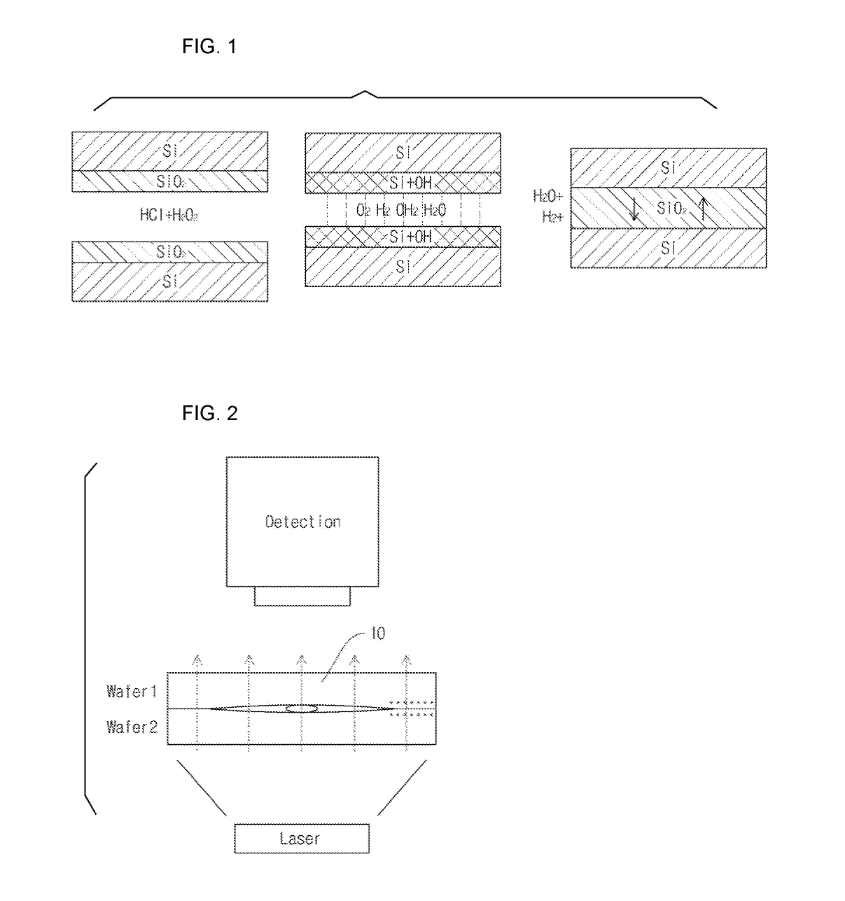

A device for inspecting a bonded wafer of the present invention is a device for detecting a defect that may occur in an interface of the bonded wafer using laser. More specifically, the bonded wafer (that is also called a “bond wafer”) is a wafer formed by coupling two wafers with respect to an oxide layer. The device detects a defect that may occur in an interface contacting the two wafers during a process of manufacturing the bonded wafer, i.e., a defect (meaning an air gap occurring due to impurities or foam, etc.) of an interface due to impurities or foam, etc. (a process of manufacturing the bonded wafer can be acknowledged with reference to FIG. 1).

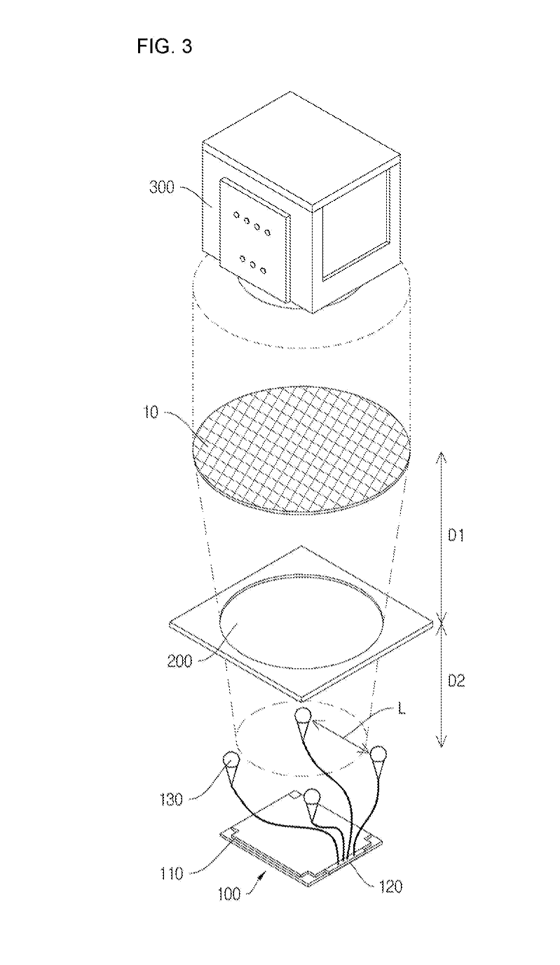

In other words, as illustrated in FIG. 2, the device for inspecting a bonded wafer 10 of the present invention is a device for detecting whether a defect exits through an image output by irradiating laser onto the bonded wafer 10 and passing the laser through the bonded wafer 10 manufactured to detect whether the defect exists due to impurities or foam, etc. between interfaces of the bonded wafer 10 bonded through the above-described manufacturing process.

If the image that passes through the bonded wafer 10 using laser as shown in FIG. 2 is sensed through a detection unit that will be described later, it is possible to detect whether a defect exists in an interface of the bonded wafer 10.

As described above, the device for inspecting the bonded wafer 10 of the present invention is a device for inspecting an interface of the bonded wafer 10 through an image obtained by irradiating laser onto the bonded wafer and photographing the image that passes through the bonded wafer 10.

As such, the device for inspecting the bonded wafer 10 of the present invention has a simple structure, is easy to operate, and is inexpensive in terms of a cost, compared to the conventional device for inspecting the bonded wafer using ultrasonic waves and an X-ray. Furthermore, the device for inspecting the bonded wafer 10 of the present invention can output a clearer defect image than an inspection equipment using infrared ray (IR).

The device for inspecting a bonded wafer using laser according to the present invention having the above-described characteristics compared to the conventional equipments of inspecting a defect of an interface of the bonded wafer will now be described below.

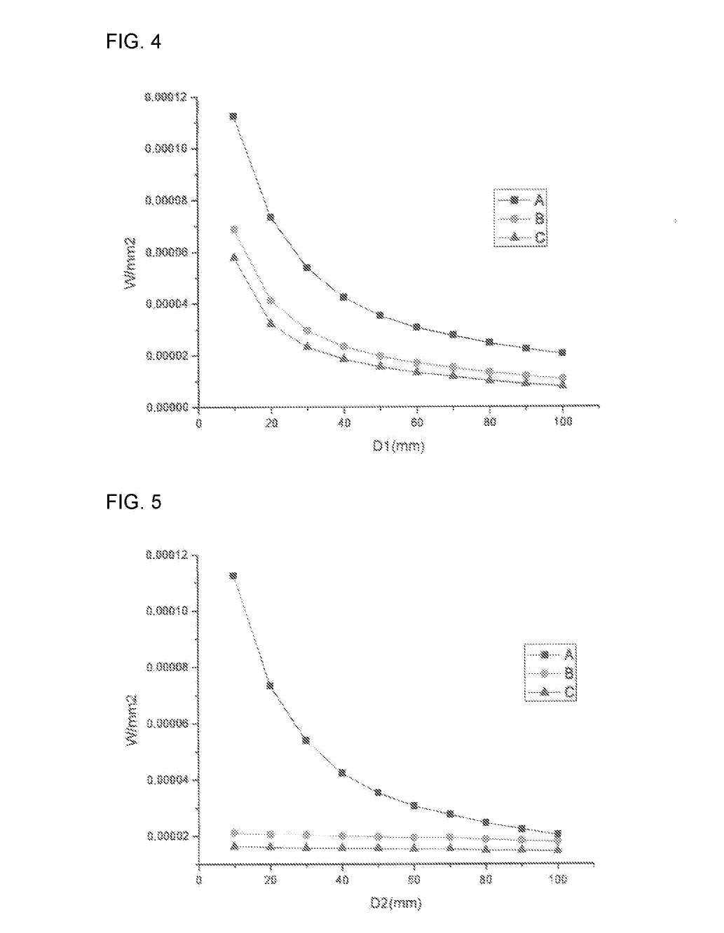

FIG. 3 is a schematic constructional diagram of a device for inspecting the bonded wafer 10 using laser according to an embodiment of the present invention.

Referring to FIG. 3, the device for inspecting the bonded wafer 10 using laser according to an embodiment of the present invention includes a laser unit 100 that emits a laser beam to the bonded wafer 10 to inspect a defect between interfaces of the bonded wafer 10 and a laser diffusion unit 200 that is disposed between the laser unit 100 and the bonded wafer 10 in such a way that the laser beam emitted by the laser unit 100 can be diffused and irradiated onto the bonded wafer 10.

The device for inspecting the bonded wafer 10 using laser according to an embodiment of the present invention further includes a detection unit 300 that detects whether the defect exists between the interfaces of the bonded wafer 10 through the laser beam that is irradiated onto the bonded wafer 10 and passes through the bonded wafer 10.

The respective elements will now be described in detail with reference to FIG. 3.

Referring to FIG. 3, the device for inspecting the bonded wafer 10 using laser according to an embodiment of the present invention includes the laser unit 100. The laser unit 100 is a unit for emitting a laser beam to the bonded wafer 10 to inspect a defect between interfaces of the bonded wafer 10 and includes a laser generation device 10, a laser separation unit 120, and a laser light source (a plurality of light sources) 130.

More specifically, the laser generation device 110 generates the laser beam so as to inspect the defect between the interfaces of the bonded wafer 10 while generating the laser beam having a wavelength greater than 1000 nm in such a way that the laser beam irradiated onto the bonded wafer 10 can pass through the bonded wafer 10. The laser generation device 100 may generate the laser beam having a wavelength greater than 1064 nm.

A numeral value of the wavelength of the laser beam generated by the laser generation device 110 is limited as described above since the laser beam does not pass through (penetrate) a wafer in a wavelength smaller than 1000 nm and passes through the wafer in a wavelength greater than 1000 nm.

The laser separation unit 120 is a device for separating the laser beam generated by the laser generation device 110 and may use a device called a light divider or a splitter.

As an example, an integrated optical light power splitter is manufactured by thermally bonding two optical fiber strands each other or detaching sides thereof and attaching them and arranging the two optical fiber strands in a substrate. The manufactured light power splitter is what is called a 1×2 light power splitter that splits one signal into two signals. An N number of outputs can be produced by connecting the 1×2 light power splitter to a cascade.

Such a light dividing technology is a conventionally widely known technology, and thus any devices capable of dividing light may be used.

A channel of the light divided by the device for inspecting the bonded wafer of the present invention may be separated into 4, 8, or 16 channels. In addition, the number of divided channels may be determined according to an initial purpose.

Further, the laser light source 130 irradiates the laser beam generated by the laser generation device 110 and separated by the laser separation unit 120 onto the bonded wafer 10. To this end, the laser light source 130 may be formed corresponding to the number of the laser beams separated by the laser separation unit 120 one-to-one.

Referring to FIG. 3, the device for inspecting the bonded wafer 10 using laser according to an embodiment of the present invention includes the laser diffusion unit 200. The laser diffusion unit 200 allows the laser beam emitted from the laser light source 130 of the laser unit 100 to be diffused and irradiated onto the bonded wafer 10.

To this end, the laser diffusion unit 200 may be disposed between the laser unit 100 and the bonded wafer 10. The laser diffusion unit 200 may use any materials capable of diffusing the laser beam, and may use, as an example, a diffusion sheet.

As described above, the device for inspecting the bonded wafer 10 of the present invention is a technology of emitting the laser beam by using the laser unit 100, diffusing the emitted laser beam by using the laser diffusion unit 200, irradiating the diffused laser beam onto the bonded wafer 10, and detecting the irradiated laser beam that passes through the bonded wafer 10 by using the detection unit 300. Reliability of an image detected through the detection unit 300 may change according to distances between the laser unit 100, the laser diffusion unit 200, and the bonded wafer 10.

In other words, a factor used to enhance the reliability of the detected image may be a laser uniformity of an inspection region with regard to a detection of an interface defect of the bonded wafer 10. The laser uniformity may be determined according to a material of the laser diffusion unit 200 that is adopted, and conditions of the distances between the laser unit 100, the laser diffusion unit 200, and the bonded wafer 10.

The best condition for the laser uniformity can be known through an experiment example that will be described later. The laser uniformity may be defined as a standard deviation of a bonded light quantity distribution. The standard deviation of the light quantity distribution by an experiment is as follows (the experiment that will be described later uses optical design software to which a Monte-Carlo simulation is applied).

TABLE 1

| | A type | B type | C type |
|---|---|---|---|
| Thickness | 1 mm | 0.05 mm | 1.6 mm |
| Material | glass | plastic | opal |
| Refractive index | 1.5 D | 1.64 D | 1.52 D |
| Transmittivity | 80% | 80% | 95% |
| Absorptivity | 20% | 20% | 5% |

As shown in Table 1 above, the experiment is conducted by classifying the laser diffusion unit 200 into three types. The laser beam emitted through the laser light source 130 has the wavelength of 1064 nm, and is irradiated in the same manner with respect to the tree types of the laser diffusion unit 200.

TABLE 2

| Laser diffusion unit | A type | B type | C type |
|---|---|---|---|
| Distance (L) between laser | 50 mm | 60 mm | 70 mm |
| light sources | | | |
| Distance (D₁) between laser | 50 mm | 60 mm | 70 mm |
| diffusion unit and bonded | | | |
| wafer | | | |
| Distance (D₂) between laser | 50 mm | 60 mm | 70 mm |
| light source and laser | | | |
| diffusion unit | | | |

As shown in Table 2 above, the laser unit 100, the laser diffusion unit 200, and the bonded wafer 10 are positioned to have the distance L between the laser light sources 130, the distance D₁ between the laser diffusion unit 200 and the bonded wafer 10, and the distance D₂ between the laser light source 130 and the laser diffusion unit 200 for each of the tree types of the laser diffusion unit 200.

After the laser unit 100, the laser diffusion unit 200, and the bonded wafer 10 are positioned as described above, before optimization starts by irradiating the laser beam starts optimized onto a wafer through the laser light source 130, the simulation was conducted 78 times (26 times for each of three types of the laser diffusion unit 200), so that D₁ and D₂ change in a range of 10 nm and 100 nm by a space of 10 mm, and L changes in a range of 15 nm and 90 nm by a space of 15 mm.

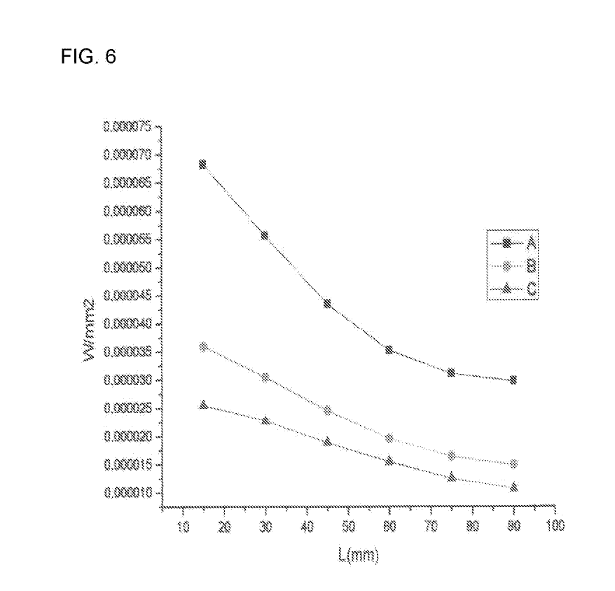

A result of the experiment shows with reference to FIGS. 4 through 6 that the standard deviation of the light quantity distribution is reduced according to a reduction in values of D₁, D₂, and L. The standard deviation of the light quantity distribution changes between 50 nm and 70 nm of D₁ and D₂ and between 45 nm and 75 nm of L, and is sensitive.

Referring to FIG. 3, the device for inspecting the bonded wafer 10 using laser according to an embodiment of the present invention includes the detection unit 300.

The detection unit 300 detects whether a defect of the bonded wafer 10 exists through the laser beam that is emitted from the laser unit 100 and passes through (penetrates) the bonded wafer 10. To this end, the detection unit 300 may include a microscope (not shown) that magnifies the laser beam passing through the bonded wafer 10 and a camera (not shown) that photographs an image displayed through the microscope.

While the laser beam passing through the bonded wafer 10 is magnified by using the microscope, a magnifying power may selectively change according to an initial examination purpose, and an inspection speed may be determined according to a size of the magnifying power. That is, a speed for detecting the defect of an interface of the bonded wafer 10 is determined according to the magnifying power through the microscope. As an example, if impurities have a large size, the bonded wafer 10 may be observed as a single sector as a whole, and, if impurities have a small size, the bonded wafer 10 may be observed after being divided into various sectors and magnified for each sector.

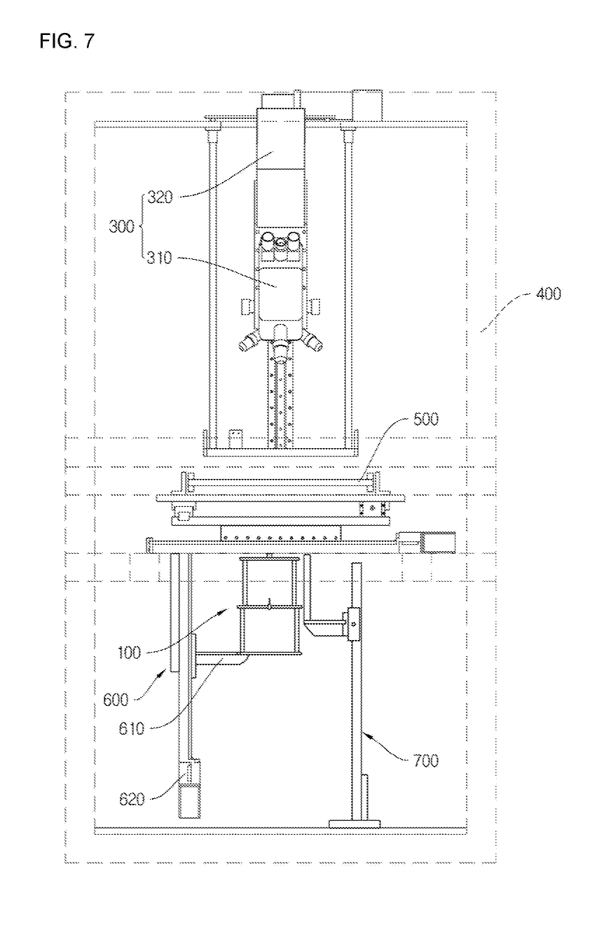

The microscope and the camera are shown in FIG. 7 that will be described later.

FIG. 7 is a diagram illustrating a device for inspecting a bonded wafer using laser according to an embodiment of the present invention.

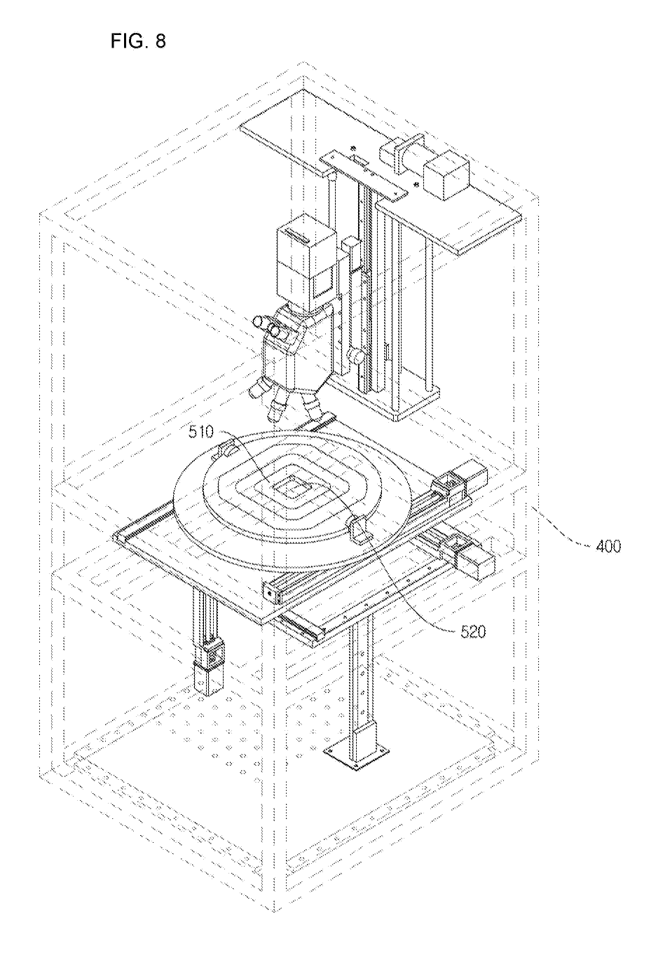

FIG. 8 is a perspective view illustrating the device of FIG. 7.

Referring to FIGS. 7 and 8, the device includes the laser unit 100, the laser diffusion unit 200, a frame 400 that fixes the detection unit 300, and a wafer holding unit 500 in which the bonded wafer that is an irradiation target of laser beam emitted through the laser unit 100 is held.

To explain the device for inspecting the bonded wafer using laser according to an embodiment of the present invention, the laser unit 100 including the laser generation device 110, the laser separation unit 120, and the laser light source 130 is disposed in the lowest part of the device. The laser unit 100 may be fixed by the frame, and can move that will be described later.

That is, the laser unit 100 can be designed to further include a laser unit movement member 600 disposed in perpendicular to one side thereof so that the laser unit 100 can move up and down. To this end, the laser unit movement member 600 may include a laser unit holding member 610 for holding the laser unit 100 and a laser unit guide member 620 for guiding the laser unit holding member 610 to move up and down.

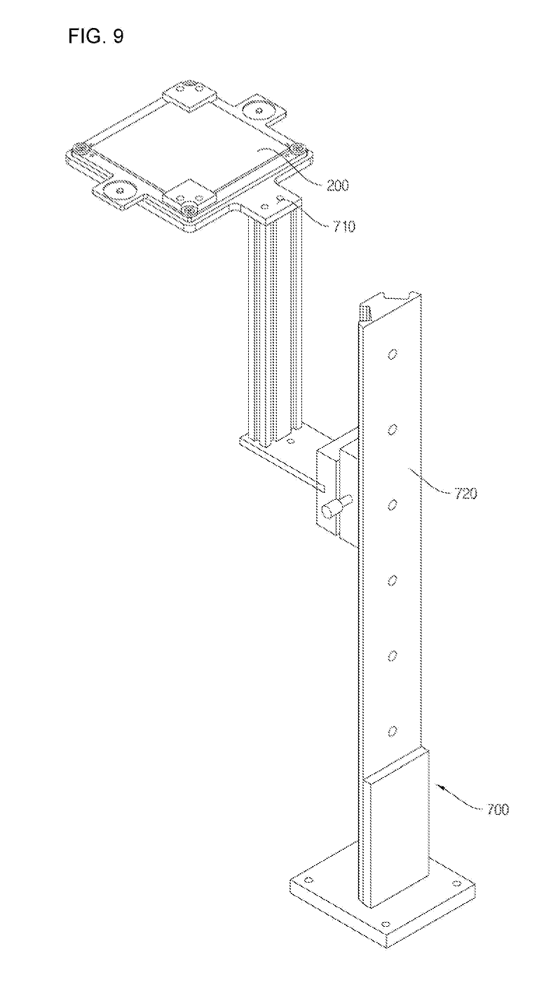

In the device for inspecting the bonded wafer using laser according to an embodiment of the present invention, the laser diffusion unit 200 is disposed spaced apart from an upper portion of the laser unit 100 by a predetermined distance. The laser diffusion unit 200 may be fixed by the frame 400, and may be movable by further including a laser diffusion unit movement member 700 as shown in FIG. 9.

To this end, the laser diffusion unit movement member 700 may include a laser diffusion unit holding member 710 for holding the laser diffusion unit 200 and a laser diffusion unit guide member 720 for guiding the laser diffusion unit holding member 710 to move up and down.

In the device for inspecting the bonded wafer using laser according to an embodiment of the present invention, the wafer holding unit 500 for holding the bonded wafer is disposed spaced apart from an upper portion of the laser diffusion unit 200 by a predetermined distance.

The wafer holding unit 500 may include a support unit 510 for supporting a circumferential edge of the held holding wafer so that the bonded wafer can be held and a hole 520 formed in the center of the wafer holding unit 500 so that the laser beam can pass through the bonded wafer.

Further, the wafer holding unit 500 may be designed to adjust a diameter of the hole 520 formed in the center of the wafer holding unit 500 corresponding to a diameter of the held bonded wafer in such a way that the bonded wafer can be held without regard to a size of the bonded wafer. To this end, the wafer holding unit 500 may be designed as a combination of a plurality of wafer holding units 500 in accordance with a size of the bonded wafer as shown in FIG. 8.

Furthermore, in the device for inspecting the bonded wafer using laser according to an embodiment of the present invention, the detection unit 300 including a microscope 310 and a camera 320 is disposed spaced apart from an upper portion of the wafer holding unit 500 by a predetermined distance. The detection unit 300 may be fixed by the frame 400 and may be designed to move up and down by using a separate movement unit.

As described above, the respective movement members, i.e. the laser unit movement member 600, the laser diffusion unit movement member 700, and the detection unit movement member 800, may be controlled to move up and down by using a separate motor. More specifically, one motor may be used to control the respective movement members or the respective movement members may be designed to include their respective motors.

If a device of inspecting a bonded wafer using laser according to the present invention is used, it is possible to advantageously inspect a wafer interface at a magnification desired by an inspector. In addition, the device has a simple structure, and thus it is advantageously easy to operate the device. Furthermore, an economical gain can be obtained owing to the simple structure.

Furthermore, in addition to the inspection of the interface of an SOI wafer manufactured using bonding, a device of inspecting a bonded wafer using laser applicable to an oxide single crystal wafer used in a cellular phone, a gallium arsenide (GaAs) wafer used in an LED, etc. can be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A device for inspecting a bonded wafer using laser, the device comprising:
a laser unit for emitting a laser beam used to inspect a defect between interfaces of the bonded wafer;
a laser diffusion unit disposed between the laser unit and the bonded wafer so that the laser beam emitted from the laser unit can be diffused and irradiated onto the bonded wafer; and
a detection unit for detecting whether a defect of the bonded wafer exists through the laser beam irradiated onto the bonded wafer and passing through the bonded wafer.

2. The device of claim 1, wherein the laser unit generates the laser beam having a wavelength greater than 1000 nm so that the laser beam irradiated onto the bonded wafer can pass through the bonded wafer.

3. The device of claim 1, wherein the laser unit comprises:
a laser generation device for generating the laser beam used to inspect the defect between interfaces of the bonded wafer;
a laser separation unit for separating the laser beam generated by the laser generation device; and
a laser light source formed corresponding to the number of the laser beams separated by the laser separation unit so that the laser beam generated by the laser generation device can be irradiated onto the bonded wafer.

4. The device of claim 1, wherein the detection unit comprises:
a microscope for magnifying the laser beam passing through the bonded wafer; and
a camera for photographing an image displayed through the microscope.

5. The device of claim 3, wherein a distance between the laser light sources is 75 mm, a distance between the laser light sources and the laser diffusion unit is 70 mm, and a distance between the laser diffusion unit and the bonded wafer is 70 mm.

6. The device of claim 1, further comprising:
a wafer holding unit comprising a support unit for supporting a circumferential edge of the bonded wafer so that the bonded wafer can be held and a hole formed in the center of the wafer holding unit through which the bonded wafer can pass; and
a frame for allowing the laser unit, the laser diffusion unit, the wafer holding unit, and the detection unit to be sequentially disposed.

7. The device of claim 6, wherein the wafer holding unit is configured to adjust a diameter of the hole formed in the center of the wafer holding unit corresponding to a diameter of the held bonded wafer so that the bonded wafer can be held without regard to a size of the bonded wafer.
